(19) United States
(12) Patent Application Publication
(10) Pub. No.: US 2019/0223430 A1
(43) Pub. Date: Jul. 25, 2019

(54) DEVICE FOR TRAPPING AND KILLING RODENTS

(71) Applicant: Dennis Theriault, Sanford, ME (US)

(72) Inventor: Dennis Theriault, Sanford, ME (US)

(21) Appl. No.: 15/875,078

(22) Filed: Jan. 19, 2018

(51) Int. Cl. A01M 23/30; A01M 23/16

(52) U.S. Cl. CPC A01M 23/30; A01M 23/16

(57) ABSTRACT

The invention provides a device for trapping and killing rodents comprising one to a plurality of rectangular box shaped enclosures containing rodent snap traps having spring-loaded bars, the enclosure having a height, a width and a length, wherein the length and width are adapted to the length and width of a rodent snap trap, and wherein the height is adapted to accommodate the spring loaded bar closing within the enclosure, and wherein the enclosure has a front end and a back end, wherein the back end is closed and the front end is fully open, and wherein the open front end has a spacer having a length adapted to place the open ends of the enclosures at a distance from a wall that is sufficient for a rodent to pass between the wall and enter the enclosures.

### BACKGROUND OF THE INVENTION

The invention relates to rodent control. More particularly, the invention relates to snap trap devices for trapping and killing rodents. A typical snap trap, or spring-loaded bar trap, comprises a substrate, commonly made of wood, with a bait tray trip section that engages a restraining bar that restrains a spring loaded bar when armed. The rodent steps on the bait tray trip releasing the restraining bar, such that the spring loaded bar is released, trapping and killing the rodent. While commonly used, these snap traps have several disadvantages. Their exposed nature makes them a danger for household pets or children. Rodents can come to them from the back or side of the trap, avoiding being captured. The spring mechanism can make the trap jump upwards, thereby avoiding trapping the rodent. Also, rodents can learn to take the bait from the bait tray trip section without triggering the trap.

Hale, US Patent Application Publication No. 2006/0156617 discloses an enclosure for the trap to ameliorate some of the problems. However, this device also has several disadvantages. It requires a hinged roof to place the trap in the enclosure and to remove it. It has no mechanism to steer the mouse into the enclosure. The device is also expensive to make and cumbersome to deploy. And each device can only trap one rodent.

There is, therefore, a need for a new device to overcome the problems with snap traps. Such a device should ideally be cheap to make, easy to deploy, easy to ship and store, and able to trap and kill more than one rodent.

### BRIEF DESCRIPTION OF THE DRAWINGS

FIG. 1 shows a two-chambered cardboard mouse trap enclosure.

FIG. 2 shows a two-chambered cardboard rat trap enclosure.

FIG. 3 shows a “clam shell” four-chambered wooden mouse trap enclosure.

FIG. 4 shows a “clam shell” four-chambered wooden rat trap enclosure.

### DESCRIPTION OF THE PREFERRED EMBODIMENTS

The invention provides devices for trapping and killing rodents. The devices are cheap to make, easy to deploy, easy to ship and store, and in some preferred embodiments, able to trap and kill more than one rodent.

In some embodiments, the device according to the invention comprises one to a plurality of rectangular box shaped enclosures containing rodent snap traps having spring-loaded bars, the enclosure having a height, a width and a length, wherein the length and width are adapted to the length and width of a rodent snap trap, and wherein the height is adapted to accommodate the spring loaded bar closing within the enclosure, and wherein the enclosure has a front end and a back end, wherein the back end is closed and the front end is fully open, and wherein the open front end has a spacer having a length adapted to place the open ends of the enclosures at a distance from a wall that is sufficient for a rodent to pass between the wall and enter the enclosures.

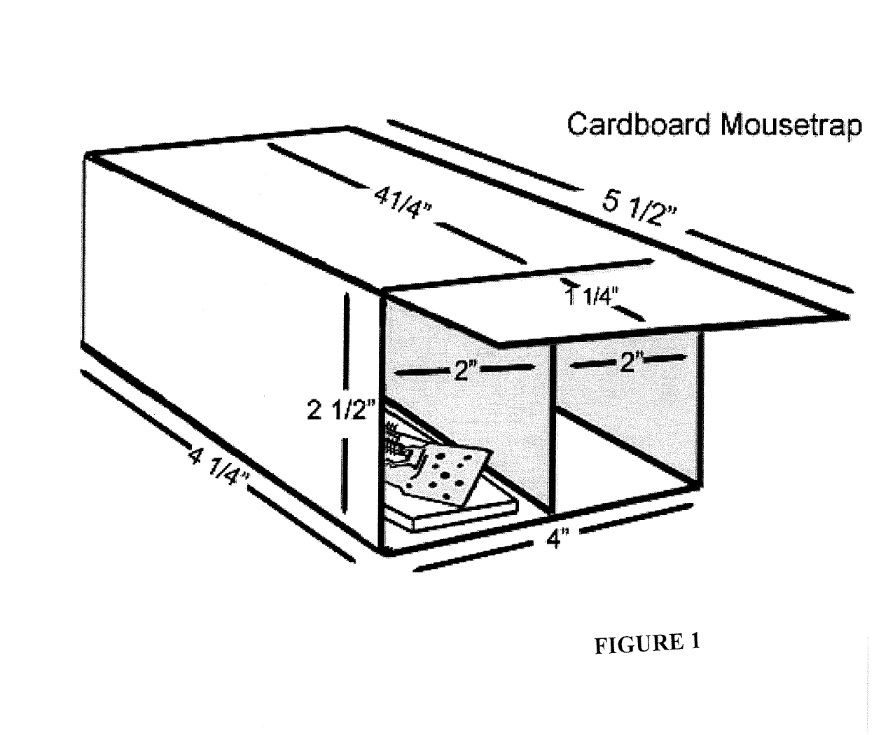

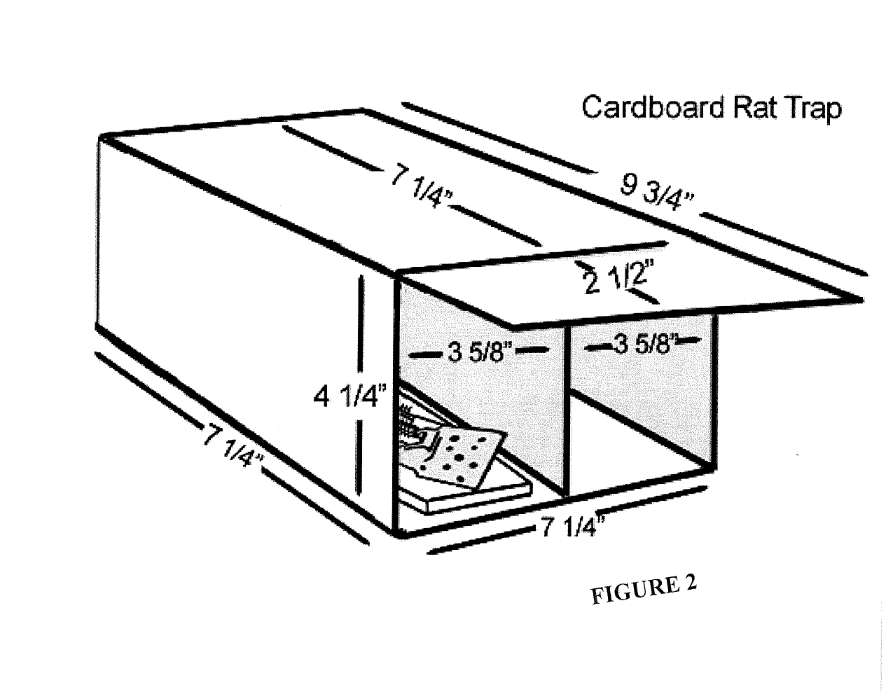

Turning to the drawings, FIG. 1 shows a front view of an embodiment of the invention having 2 enclosures. The spacer can be seen at the top of the enclosures. FIG. 2 shows another embodiment of the invention having 2 enclosures. When the flaps are open, and the snap traps removed, the enclosure portion of the device can be flattened, for convenient shipping and storage.

From the description and the drawings several advantages of this embodiment become apparent. The enclosure portion of the device ban be made of any suitable material, such as cardboard, chipboard or plastic, which provides simple, rapid and cheap manufacture of the enclosures, cheap enough to be used as a disposable, if desired. Because the front end is fully open, there is no need to have a hinged lid to insert and remove the snap trap. Rodents tend to travel on floors next to walls, so the spacer effectively guides them to the trap. The device can be sized to fit any size snap trap, so it can be used for mice or for rats. The bait, such as peanut butter can be spread on the inner back wall easily, simply by opening the tab and flaps that form the back end. When the tab and flaps are open, and the snap trap is removed, the device can be folded flat, allowing for easy shipping and storage. The device can be in the form of a single enclosure or a plurality of enclosures. Surprisingly, rodents will enter an enclosure even if another enclosure contains a dead, trapped rodent. The rodent has to climb over the trap to get to the bait, so it cannot steal the bait without springing the trap.

In one exemplary embodiment, the enclosure portion of the device, sized for a mouse snap trap is about 2½″ tall, 2″ wide and 4¼″ long with a 1¼″ spacer. In another exemplary embodiment, the enclosure portion of the device, sized for a rat snap trap is about 4⅝″ tall, 3¾″ wide and 7″ long with a 2½″ spacer. Those skilled in the art will recognize that these dimensions can be altered to accommodate any size snap trap.

In one preferred embodiment, multiple enclosure arrays can be provided in a flat package, with the flaps the form the back wall of the enclosures open. The bait, e.g., peanut butter, is easily spread on the inside of the flaps that form the back wall or generally at the back of the enclosure. Then the flaps are closed, and the tab inserted to hold them in place. The snap trap is then armed and inserted into the open front end. In some preferred embodiments, the snap trap is inserted with the with the trip section facing the back of the enclosure. The device is then placed on the floor, with the open end facing the wall and the spacer touching the wall, thus providing passage of the rodent along the wall and into an enclosure. When one or more rodents are captured, they can be removed simply by tipping the enclosures forward.

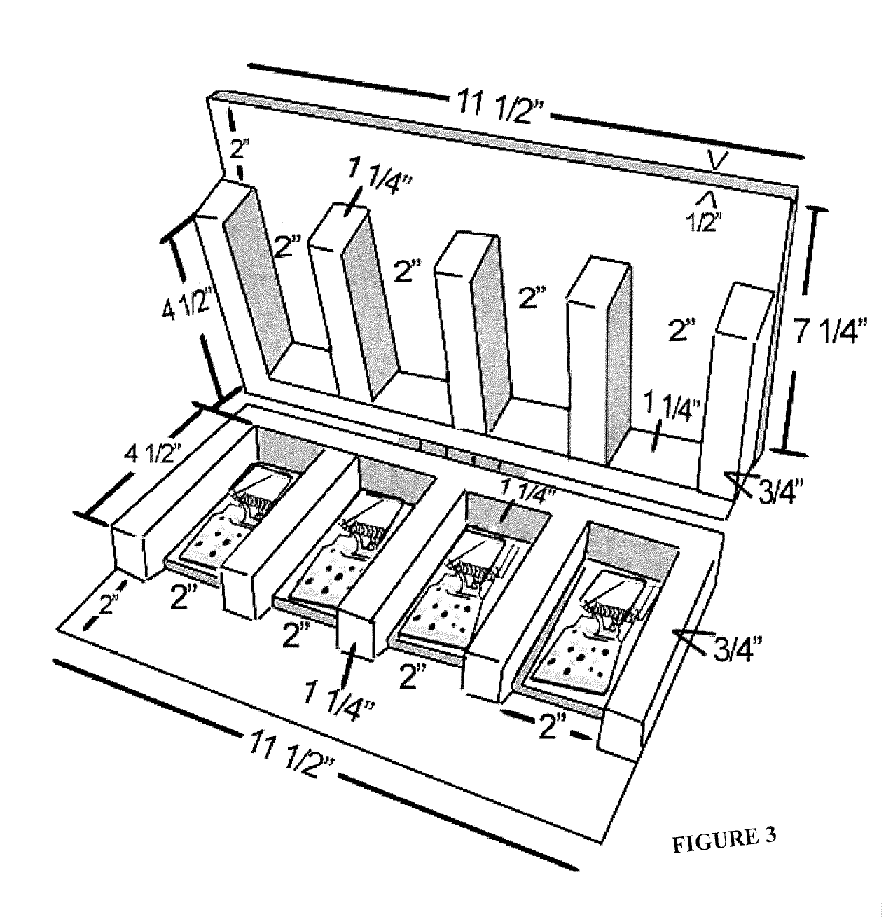

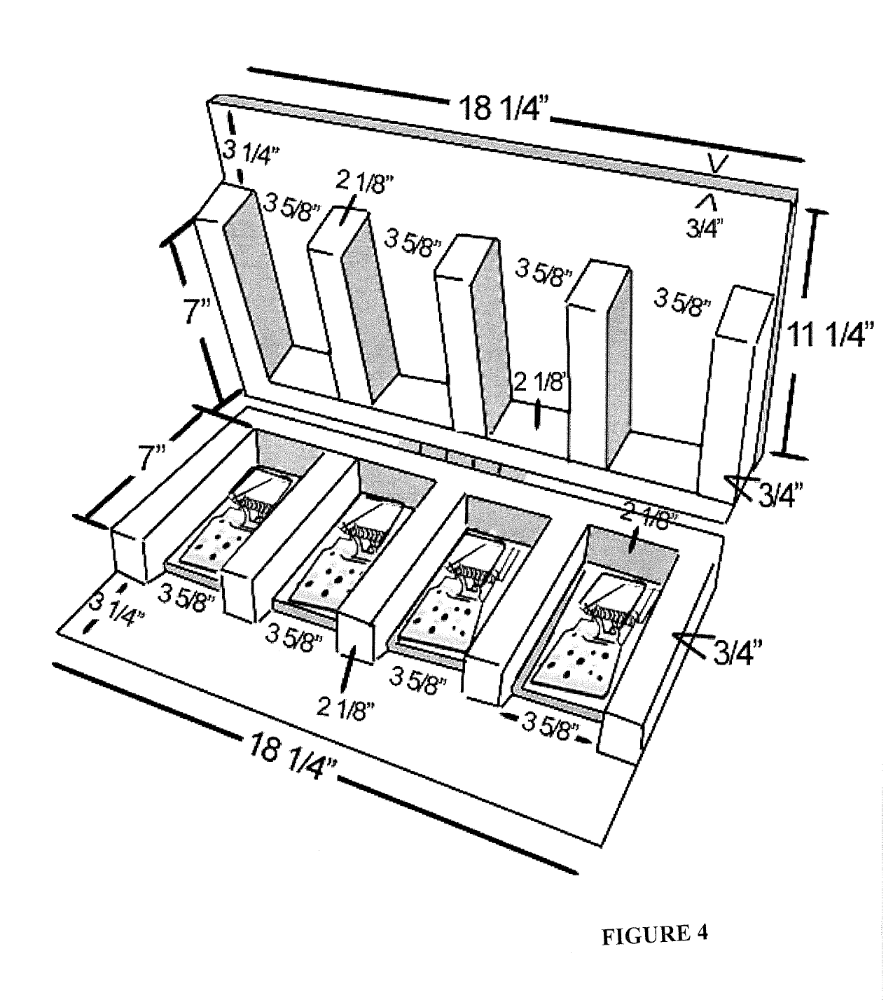

In a second preferred embodiment, the device can be configured like a clam shell, wherein the plurality of enclosures are made up from both the upper “shell” and the lower “shell”. FIG. 3 shows a front view of this embodiment. FIG. 4 shows an elevated front view of this embodiment, in which the “shell” is open and the armed snap traps are in place. The device according to this embodiment of the invention comprises a plurality of rectangular box shaped enclosures containing rodent snap traps having spring-loaded bars, the enclosure having a height, a width and a length, wherein the length and width are adapted to the length and width of a rodent snap trap, and wherein the height is adapted to accommodate the spring loaded bar closing within the enclosure, and wherein the enclosure has a front end and a back end, wherein the back end is closed and the front end is fully open, and wherein the open front end has a spacer having a length adapted to place the open ends of the enclosures at a distance from a wall that is sufficient for a rodent to pass between the wall and enter the enclosures. The enclosure portion of this embodiment can be made from any suitable material, such as wood, cardboard, chipboard or plastic, In this embodiment, to deploy the device the “shell” is opened, the armed snap traps are deployed and the back of the enclosure is baited, e.g., as shown in FIGS. 3 and 4.

What is claimed is:

1. A device for trapping and killing rodents comprising one to a plurality of rectangular box shaped enclosures containing rodent snap traps having spring-loaded bars, the enclosure having a height, a width and a length, wherein the length and width are adapted to the length and width of a rodent snap trap, and wherein the height is adapted to accommodate the spring loaded bar closing within the enclosure, and wherein the enclosure has a front end and a back end, wherein the back end is closed and the front end is fully open, and wherein the open front end has a spacer having a length adapted to place the open ends of the enclosures at a distance from a wall that is sufficient for a rodent to pass between the wall and enter the enclosures.

2. The device according to claim 1, wherein the device has a plurality of enclosures.

3. The device according to claim 1, wherein the device has a single enclosure.

4. The device according to claim 1, wherein the rodent is a mouse.

5. The device according to claim 1, wherein the rodent is a rat.

6. The device according to claim 1, wherein the enclosure portion of the device is constructed of cardboard.

7. The device according to claim 1, wherein the enclosure portion of the device is constructed of plastic.

8. The device according to claim 1, wherein the enclosure portion of the device is constructed of chipboard.

9. The device according to claim 1, wherein the enclosure portion of the device is constructed of wood.

10. The device according to claim 1, wherein the back end consists of three flaps and a tab.

11. The device according to claim 8, wherein when the flaps are opened, the device can be folded flat.
